(19) United States
(12) Patent Application Publication
(10) Pub. No.: US 2025/0177935 A1
(43) Pub. Date: Jun. 5, 2025

(54) KIRIGAMI MIXERS AND METHODS OF USE

(71) Applicants: Sartorius Stedim Biotech GmbH, Göttingen (DE); Trustees of Boston University, Boston, MA (US)

(72) Inventors: Samin Akbari, Winchester, MA (US); Douglas Holmes, Jamaica Plain, MA (US); Yi Yang, West Newton, MA (US); David James Pollard, Stow, MA (US)

(73) Assignees: Sartorius Stedim Biotech GmbH, Göttingen (DE); Trustees of Boston University, Boston, MA (US)

(21) Appl. No.: 18/840,766

(22) PCT Filed: Mar. 1, 2023
(86) PCT No.: PCT/US2023/014262

§ 371 Date: Aug. 22, 2024

Related U.S. Application Data
(60) Provisional application No. 63/315,506, filed on Mar. 1, 2022.

(51) Int. Cl. B01F 31/55; B01F 35/513

(52) U.S. Cl. CPC B01F 31/55; B01F 35/513

(57) ABSTRACT

Kirigami mixing systems and related methods are generally described. In some embodiments, a mixing system includes one or more grippers configured to deform a portion of a flexible container containing fluid when undergoing axial deformation. The grippers may include features including slots, hinges, and spines to aid in the transition of the grippers between a closed and retracted configuration when the one or more grippers are deformed. The compression of the container subsequently result in fluid flow within the container which may mix or agitate the fluid. In some embodiments, the described grippers may be formed integrally with the flexible containers. In some embodiments, the mixing system may include a plurality of grippers arranged around the flexible container.

### CROSS-REFERENCE TO RELATED APPLICATIONS

This application claims the benefit under 35 U.S.C. § 119(e) of U.S. provisional application Ser. No. 63/315,506, filed Mar. 1, 2022, the entire contents of which is incorporated by reference in its entirety.

### FIELD

The technology is generally related to devices and methods of fluid mixers. More specifically, methods and apparatuses including Kirigami mixers are disclosed.

### BACKGROUND

Fluid mixers are conventionally used in a variety of applications to agitate fluids in containers. Fluid mixers can allow the fluid agitation process to occur automatically and, in some instances, continuously, which may improve throughput and efficiency when compared to manual mixing processes. In some instances, the mixers can include a motor-driven component (e.g. a propeller) to generate a vortex and mix the fluid. Alternatively, fluid mixers can include a fluid container resting on a rocking platform which moves in a controlled elliptical fashion to agitate the fluid resulting in the desired mixing.

### SUMMARY

In one embodiment, a fluid mixing system includes one or more supports configured to support a flexible container containing a fluid and one or more grippers configured to receive at least a portion of the flexible container within the one or more grippers when the container is supported by the one or more supports. The one or more grippers are configured to deform the flexible container to induce flow of the fluid within the flexible container.

In another embodiment, a flexible container includes one or more flexible films defining a fluid volume and one or more grippers connected to the one or more flexible films and configured to deform the one or more flexible films. Additionally, each gripper of the one or more grippers includes a substrate with a plurality of jaws formed in the substrate. The one or more grippers are attached to at least a portion of the one or more flexible films such that when the one or more grippers are deformed in an axial direction, the one or more grippers deform the fluid volume.

In yet another embodiment, a method of mixing a fluid disposed inside of a flexible container includes displacing opposing end portions of one or more grippers in opposing directions and closing a plurality of jaws of the one or more grippers in response to the applied displacement to compress at least a portion of the flexible container between the plurality of jaws. Additionally, the fluid disposed inside of the flexible container undergoes mixing upon compression of the container.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic perspective view of one embodiment of a mixing system;

FIG. 2 is a photograph of another embodiment of a mixing system;

FIG. 3A is a schematic front view of one embodiment of a mixing system in the retracted configuration;

FIG. 3B is a schematic front view of the embodiment of FIG. 3A in the closed configuration;

FIG. 4A is a schematic side view of another embodiment of a mixing system;

FIG. 4B is a schematic side view of the embodiment from FIG. 4A in a closed configuration;

FIG. 5A is a photograph of one embodiment of a gripper;

FIG. 5B is a photograph of one embodiment of a gripper;

FIG. 6 is a schematic front view of another embodiment of a mixing system;

FIG. 7 is a schematic front view of yet another embodiment of a mixing system;

FIG. 8A is a schematic front view of yet another embodiment of a mixing system;

FIG. 8B is a schematic front view of yet another embodiment of a mixing system;

FIG. 9 is a schematic top view of yet another embodiment of a mixing system;

FIG. 10 is a schematic top view of yet another embodiment of a mixing system;

FIG. 11 is a schematic top view of yet another embodiment of a mixing system;

FIG. 12A is a schematic top view of yet another embodiment of a mixing system; and

FIG. 12B is a schematic top view of yet another embodiment of a mixing system.

### DETAILED DESCRIPTION

Existing fluidic handling systems conventionally use structures (such as propellers, as described previously) that are disposed within a fluid and driven to generate vortices in the fluid. In one exemplary system, a magnetic stir bar can be inserted into a container of fluid and placed on a platform that may magnetically rotate the stir bar. The inventors have recognized that this category of fluid mixers may suffer from a lack of parallelization and throughput. In addition, rigid actuators may induce high shear stresses within the fluid, which may inhibit or otherwise damage biological material that may be contained within the fluid.

Alternative existing fluidic systems make use of moving platforms to agitate fluid within a container resting on the moving platform. While this type of system may provide automated and controlled agitation of the fluid, the inventors have recognized that moving platforms (e.g. rocking cell culture platforms) typically require costly equipment with large footprints. These disadvantages may limit the utility of these platforms. In addition, the throughput of these platforms can only be improved by increasing the footprint of the platform. In other words, it may be possible to mix several containers in parallel, but the platform must be suitably large to accommodate the containers simultaneously.

In view of the above, the Inventors have recognized the benefits associated with fluid mixers which make use of one or more grippers to deform a flexible container containing fluid. The deformation of the flexible container may induce flow within the container and mix the fluid contained therein. The grippers may be configured to dynamically interface with the container such that the transition between different configurations of the grippers, as further described below, may agitate the fluid disposed in the interior volume of the container.

The embodiments of mixing systems described herein may provide a relatively smaller footprint as compared to existing mixing systems, and in some instances may facilitate parallel and/or automated operation of the mixers. In addition, the disclosed mixing systems may be low-cost and lightweight as compared to existing bulky fluid mixers. It should be appreciated that in some embodiments, the grippers may also induce more gentle fluid flow in the fluid within the flexible container when compared to mixers with rigid propellers. Accordingly, lower shear stresses may be applied to the fluid. In embodiments where the fluid contains biological materials such as cells, this reduction in shear stress may improve the viability of the cell cultures.

In some embodiments, the one or more grippers of a fluid mixing system may transition between a configuration in which the grippers are in a first retracted configuration. Depending on the type of gripper used, this may correspond to a state in which the grippers are undeformed. The one or more grippers may transition between the retracted configuration and a closed configuration in which the grippers are in contact with and deform the flexible container to a greater extent than in the retracted configuration. As elaborated on further below, the one or more grippers may transition to the closed configuration when the grippers are deformed along a longitudinal axis of the associated gripper. Movement of the grippers between these two configurations may induce motion of fluid within the flexible container as the flexible container is cyclically deformed by one or more associated grippers. In this way, the fluid within the flexible container may be mixed.

In some embodiments, the fluid within the flexible container may be a liquid such as a liquid solution. In some embodiments, the flexible container may include both a liquid solution and a gas (e.g. nitrogen) or mixture of gases (e.g. air). In some embodiments, the liquid solution within the flexible container may include pharmaceutical ingredients, bulk drug substances, buffers, cell media, active ingredients, medicament, food products, any combination thereof, or any other suitable material, as the present disclosure is not so limited.

In some embodiments, the grippers may be configured to move between the previously described retracted and closed configurations upon axial deformation of the associated gripper. For example, the grippers may be connected to actuators capable of displacing opposing portions of the grippers in opposing directions along an axial direction extending along, or parallel to, a longitudinal axis of the gripper. Accordingly, the opposing portions of the grippers may be attached (either removably or permanently) to linkages or other connections associated with the actuators. The actuators may then displace the associated portions of the one or more grippers away from one another (or towards one another), such that the grippers transition between the retracted and closed configurations. It should be appreciated any appropriate type of actuator may be used to controllably displace the opposing portions of the grippers. This may include but is not limited to actuators including, but not limited to, actuators including crankshafts, actuators including torsional springs, actuators including ball screws, actuators including cams, pneumatic actuators, piezoelectric actuators, solenoid actuators, hydraulic actuators, or any other type of actuator capable of providing the desired deformation as the present disclosure is not so limited.

In some embodiments, the grippers described herein may be formed by elastic sheets that may be deformed to transition the grippers between the above noted retracted and closed configurations. The grippers may include a combination of spines, hinges, and slots formed in the elastic sheet to provide the desired functionality in some embodiments. For example, the slots, hinges, and/or spines may be formed in a pattern. In one such embodiment, the pattern may include a lattice of slots which may form the hinges and one or more spines of the grippers where the hinges may be living hinges corresponding to small regions of material between adjacent sections of the patterned elastic sheet. The type of movements exhibited by a given gripper may depend on the pattern and positioning of the slots formed in the grippers. In other words, different modes of deformation may be achieved with different designs and arrangements of the slots. In some embodiments, the combination of slots, hinges, and spines of the grippers may be in a Kirigami formation. In such an embodiment, a gripper may deform between the retracted and closed configurations in an elastic fashion when two or more opposing portions of the gripper are subjected to an axial deformation. In other words, portions of the grippers may deflect in a direction normal (or otherwise different from) a direction of deformation applied to the gripper, which in some embodiments may be oriented along a longitudinal axis of the gripper. In some embodiments, the deflection of the one or more grippers, may cyclically compress and expand one or more portions of an associated container.

It should be understood that the spines and slots formed in a substrate, such as an elastic sheet, corresponding to a gripper may have any appropriate configuration for a desired application. In some embodiments, the slots may be formed during fabrication of the grippers such that the slots may be portions of the gripper without any material. In other words, the slots may be gaps or openings in the gripper structure that enable the specific deformation of the gripper. In other embodiments, the slots may be cut or otherwise removed from the substrate of a gripper after fabrication. For example, the slots may include a pattern of cuts and/or openings formed in the substrate. It should be appreciated that the slots may be formed in the grippers using laser cutting, stamping, etching, any combination thereof, or any other suitable technique as the present disclosure is not so limited.

The one or more spines of a gripper may span across at least a portion of an axial length of a gripper. In some embodiments, the spines may span directly across at least a portion of the substrate forming a gripper along the axial length of the gripper, while in other embodiments, the one or more spines may follow a tortuous path across at least a portion of the substrate along the axial length of the gripper. In some embodiments, the spines, flaps, and slots may be formed in a single monolith substrate. In other embodiments, the various components of the gripper may be joined to form an integrated substrate.

In some embodiments, the slots formed in a substrate may form living hinges in the clastic sheet, or other substrate, of a gripper, such that the hinges may undergo significant deformation during use. For example, the hinges may have a smaller cross-sectional area than other portions of the gripper (e.g. the spines) such that the hinges are more susceptible to local elastic deformation when overall deformations are applied to the gripper. Thus, the hinges may facilitate deformation of the overall gripper such that opposing jaws formed in, or attached to, a substrate of the gripper may be moved towards one another from the retracted configuration where the jaws are further apart into the closed configuration where the jaws are closer together. Specific structures are elaborated on further below with regard to the figures.

As noted above, in some embodiments, the grippers may include jaws formed on either side of a longitudinal axis of the gripper. In embodiments where the grippers are substantially planar in the retracted configuration, i.e. a planar elastic sheet, the jaws may be configured to undergo out-of-plane deflection towards one another as the gripper is moved into the closed configuration when the gripper is axially deformed. In some embodiments, the jaws may be configured to apply a compressive force to a portion of the container when in contact with the container. It should be appreciated that dependent upon the configuration of the grippers, the jaws may either be in contact with or spaced from the container either in the retracted configuration, as the present disclosure is not so limited.

In some embodiments, the spines, hinges, and slots may be formed on a monolithic substrate that a gripper is formed from. For example, described further herein, in some embodiments, the slots, hinges, and spines may be formed in a single integrally formed clastic sheet. However, in other embodiments, the various portions of an elastic sheet used to form a gripper may be assembled from separately formed components that are connected to one another. In one exemplary embodiment, the hinges may be made of a different material than the spines that are connected to one another by the hinges. For instance, the hinges might be made from a more clastic material. In this way, the elasticity of the gripper may be improved, while the jaw portions may be relatively more rigid to help improve the effective force transfer from the gripper to the associated fluid container.

In some embodiments of a mixing system, the grippers may be a reusable and/or permanent component of the mixer that may be reused with multiple separate containers that are positioned within the mixing system. In these embodiments, a desired container may be supported by a suitable support structure and received in the one or more grippers which may then be actuated to mix the contents of the flexible container. Once the grippers have suitably mixed the container, the container may be removed, and a new container may be positioned at least partially within the one or more grippers for mixing as well. In this way, the grippers may be reused in an overall integrated system.

In other embodiments, the grippers may be integrated with the flexible container itself. In some embodiments, the gripper may be fabricated as part of the flexible container whereas in other embodiments, the grippers may be attached to one or more portions of the flexible container. It should be appreciated that the grippers may be attached to the flexible container with any suitable method, including, but not limited to, high frequency welding, hot plate welding, induction welding, solvent welding, spin welding, laser welding, ultrasonic welding, extrusion-based sealing, hot sealing, cold sealing, adhesives, combinations of the forgoing, and/or any other suitable method, as the present disclosure is not so limited. In some embodiments, the grippers may be attached to the container in a removeable fashion. For example, the flexible container and the grippers may include complementary features which may be attached to one another in a simple and cost-effective manner. In embodiments where the grippers are integrated onto a portion of the container, the container may be configured to be single-use. In other words, the grippers and container may form an integrated disposable unit. It should be appreciated that depending on the type of attachment between the container and the integrated grippers and/or the method of manufacture, the grippers may be made of either the same, or a different material as the container.

In some embodiments, when engaged with a container, the jaws of a gripper may extend from at least one side (i.e. end portion) towards an opposing portion of the associated flexible container. In other words, the jaws may extend across at least a portion of the container. In some embodiments, the jaws may extend across the entire container such that a width of the jaws (measured normal to the axial dimension of the grippers) may be substantially equal to, or greater than, a width of the container or other corresponding dimension of the container the jaws extend across. In some embodiments, the jaw width (either in the closed or retracted configuration) may be at least 5%, 10%, 20%, 30%, 40%, 50%, 60%, 70%, 80%, 90%, 95%, or any other suitable percentage of a corresponding dimension of a portion of the flexible container the jaws extend across in the closed configuration. The jaw width may also be less than or equal to 100%, 95%, 90%, 80%, 70%. 60%, 50%, or any other appropriate percentage of the corresponding dimension of the flexible container. Combinations of the ranges are contemplated including a width of the jaws that may be between 5% and 20% or 5% and 100% of the container width or other corresponding dimension of the container aligned with a direction in which the jaws extend in the closed configuration. Of course, other ranges, including ranges both greater than and less than those noted above are also contemplated as the disclosure is not so limited.

In some embodiments, a gripper may extend along at least a portion of, and in some instances an entire, length of at least one side (i.e. end portion) of the flexible container it is associated with. In other words, the gripper length in the axial direction (either in the closed or retracted configuration) may be equal to some fraction of a corresponding length of the edge of the flexible container adjacent to the gripper. In some embodiments, the gripper length in the axial direction (either in the closed or retracted configuration) may be at least 5%, 10%, 20%, 25%, 30%, 40%, 50%, 60%, 70%, 75%, 80%, 90%, 95%, or any other suitable percentage of the length of the associated edge of the container. The axial length of the gripper may also be less than or equal to 100%, 90%, 80%, 70%, 60%, 50%, and/or any other appropriate percentage of the length of the associated side of the container. Combinations of the foregoing ranges are contemplated including, for example, an axial length of the gripper that is between or equal to 5% and 100% or 20% and 100% of the length of the associated side of the container. As described further below, in some embodiments, the gripper length may also be greater than the length of the associated side. For example, the gripper may be longer than the container length to accommodate more than one container at a time and/or containers of different lengths. Accordingly, it should be appreciated that the gripper may be any length both greater and less than the ranges noted above, as the present disclosure is not so limited.

In embodiments where the gripper spans less than the entire container length, the gripper may be located anywhere along the side of the container, as the present disclosure is not so limited. In some embodiments, the gripper may be positioned along a central portion of a side of a container, whereas in other embodiments, the gripper may be positioned off-center along the side of the container.

In embodiments where the gripper spans less than the entire length of the associated side of the container, the flexible container may be able to accommodate multiple grippers. For example, there may be two or more grippers distributed along a length of the side of the container. In some embodiments, there may be at least one, two, three, four, five, six, seven, eight, nine, ten, or any other suitable number of grippers along a side of the container, as the present disclosure is not so limited. It should be appreciated that the multiple grippers may each have either different of the same gripper lengths. For example, the mixing system may include three grippers, where two of the grippers span 10% of the container length and are located at opposing portions of the same side of the container, and the third gripper spans 20% of the container length and is located central to the container side. Thus, any combination of grippers with either the same or different sizes may be used.

In some embodiments, the container may accommodate multiple grippers on different sides of the container. In embodiments where the container includes four sides (e.g. when the container is substantially rectangular), there may be a pair of grippers located on opposing and/or adjacent sides of the container. As described previously, each side of the container may accommodate multiple grippers. Therefore, in some embodiments, the mixing system may include multiple grippers located along multiple sides of the container. For example, in one embodiment, there may be four grippers configured to deform the container, each gripper associated with a different side of a substantially rectangular container. It should be appreciated that there may be any suitable number of suitably sized grippers located at any suitable position of the container, as the present disclosure is not so limited.

In embodiments where the mixing system includes more than one gripper, the grippers may be controlled cyclically. For example, there may be three grippers located along a single side of the container, configured to deform the container in a sequential manner. In this embodiment, the sequence of grippers may follow a wave pattern across the side of the container and subsequently induces flow in the axial direction of the gripper in addition to the flow induced by gripping and releasing the container (which may induce flow perpendicular to the axial direction of the gripper). In another exemplary embodiment, the mixing system may include multiple grippers arranged around at least one side of the container. In this embodiment, alternating grippers may be controlled synchronously, such that when the even numbered grippers are in contact with the container, the odd numbered grippers have released the container, and vice versa. In some embodiments, the mixing system may include multiple grippers arranged on multiple sides of the container, and the group of grippers located on any given side may be operated synchronously such that the multiple grippers act as a single gripper. This configuration may be suitable for mixing systems capable of handling a wide arrangement of container sizes, such that extraneous grippers may be deactivated when a smaller container is used. It should be appreciated that the gripper/grippers may be individually or collectively controlled in any suitable manner, for example synchronously or asynchronously, as the present disclosure is not so limited. In embodiments where the mixing system includes more than one gripper, the grippers may be controlled with different actuators. Alternatively, the grippers may be controlled with the same actuators, configured to alternatively deform the grippers. It should be appreciated that any suitable configuration between the actuators and the grippers may be used as the present disclosure is not so limited.

In some embodiments, a mixing system may include at least one processor configured to control the one or more actuators responsible for deforming the grippers. The processor(s) may be responsible for operating the actuators, which in turn may deform the grippers. In some embodiments, all actuators may be controlled with a single processor, and in other embodiments, multiple separate processors may be used to control multiple separate actuators. It should be appreciated that the processor(s) may control the actuators with any suitable mode of communication, including but not limited to, a wired communication link or a wireless communication link, as the present disclosure is not so limited. In some embodiments, the processor(s) may be configured to operate the mixing system automatically and/or continuously.

The actuators (and the associated grippers) may be configured to operate at a suitable frequency to induce a desired amount of flow within the container without excessive agitation. For example, in one embodiment, the grippers cycle from the retracted configuration to the closed configuration and then back to the retracted configuration with a frequency of 1.5 Hz. However, it should be appreciated that the actuation frequency may be any appropriate frequency including frequencies that are greater than or equal to 0.01 Hz, 0.02 Hz, 0.05 Hz, 0.1 Hz, 0.5 Hz, 1 Hz, 5 Hz, 10 Hz, 20 Hz, 30 Hz, 40 Hz, 50 Hz, 60 Hz, and/or any other appropriate frequency. The actuation frequency may also be less than or equal to 100 Hz, 90 Hz, 80 Hz, 70 Hz, 60 Hz, 50 Hz, 40 Hz, 30 Hz, 20 Hz, 10 Hz, and/or any other appropriate frequency. Combinations of the foregoing ranges are contemplated including an operation frequency that is between or equal to 0.01 Hz and 100 Hz. However, frequency ranges both greater than and less than those noted above are also contemplated as the present disclosure is not so limited.

In some embodiments, the actuation of the grippers may further include an actuation amplitude. The actuation amplitude may correspond to the degree of deformation of the grippers and the size of the jaws. In some embodiments, a maximum actuation amplitude may be equal to the movement of the jaws between a fully retracted and fully closed configuration of the jaws. However, amplitudes for an individual actuation cycle that are less than this full operation range may also be applied. For example, in some embodiments, the actuation amplitude may be at least 5%, 10%, 15%, 20%, 25%, 30%, 35%, 40%, 45%, 50%, 55%, 60%, 70%, 75%, 80%, 85%, 90%, 95%, 100% or any other suitable percentage of the fully operational range of the gripper as the present disclosure is not so limited. Additionally, combinations of the above-noted ranges where the amplitude of an actuation cycle is between or equal to any of the above-noted ranges are also contemplated.

In some embodiments, a mixing system may be configured to operate at a given actuation frequency for any number of cycles to suitably mix or otherwise incubate the contents of the flexible container, wherein a cycle may include movement of the grippers between the closed and retracted configurations. In some embodiments, the mixing system may operate for at least 2, 3, 4, 5, 6, 7, 8, 9, 10, 12, 15, 18, 20, 25, 30, 35, 40, 45, 50, or 100 cycles. The number of cycles applied by a system during mixing of a container may also be less than or equal to 1000 cycles, 500 cycles, 100 cycles, 50 cycles, and/or any other appropriate number as the disclosure is not so limited. Combinations of the foregoing ranges are contemplated including, for example, a mixing system that operates one or more grippers of the system to apply between or equal to 2 mixing cycles and 1000 mixing cycles though ranges both greater than and less than those noted above are also contemplated. In some embodiments, dependent on the actuation frequency of the grippers, the mixing system may operate for any suitable period of time, including, but not limited to 2 sec, 15 sec, 30 sec, 1 min, 5 min. 30 min, 1 hr, 2 hrs, 3 hrs, 5 hrs, 10 hrs, 12 hrs, 24 hrs, 2 days, 5 days, 10 days, or any other suitable period of time. Correspondingly, the mixing system may be operated for less than 300 days, 200 days, 100 days, 50 days, 10 days, 1 day, and/or any other appropriate time period when mixing the contents of a given container. Combinations of the above-noted ranges are contemplated including, for example, a mixing time period that is between or equal to 2 seconds and 300 days may be used. Accordingly, it should be understood that a gripper and container may be configured to operate using any suitable duration and/or frequency to provide a desired amount of mixing over a given time period.

In some embodiments, the flexible container may rest on a support. The support may provide support to the container when the grippers are not in contact with the flexible container. For example, the container may simply be placed on a supporting surface in such an embodiment. In some embodiments, the support may only partially support the flexible container, such that the grippers may grip the container without interference from the support. It should be appreciated that the support may support the flexible container with any suitable configuration, as the present disclosure is not so limited.

In other embodiments, the flexible container may be supported by a support that is configured to at least partially suspend the container from the support on at least one side. This configuration may reduce the footprint of the mixing system and may enable multiple containers to be mixed in parallel in a smaller footprint of space. Accordingly, the flexible container may be hung from a support which may include a clamp, hook, or other attachment arrangement to effectively hold the flexible container and prevent accidental release of the flexible container, which may contaminate or otherwise damage the container. For example, in some embodiments, the container may be connected to the support using a hook inserted into an eyelet on the container, a clamping arrangement may be used, and/or any other appropriate connection method may be used as the disclosure is not so limited. It should be appreciated that the flexible container may be hung in any suitable arrangement as the present disclosure is not so limited. Depending on the embodiment, the support may be part of a reusable mixing system where the support is configured such that separate containers may be sequentially attached to and removed from the mixing system. In other embodiments, the clamp may be configured to be part of the container itself.

The flexible container may be composed of a plurality of films. In some embodiments, the films may be sufficiently flexible to allow the grippers to sufficiently deform the container to mix the contents contained within an interior of the container. Accordingly, the container may be made of a single-layer or multilayer film, which may include polyethylene, poly or an ethylene-vinyl acetate copolymer. In some embodiments, the films may be composed of one or more layers of polymers including, but not limited to, polypropylene, polyethylene, ethylene vinyl alcohol, polyamide, polychlorotrifluoroethylene, cyclic olefin copolymer, polycarbonate, ethylene vinyl acetate, polyvinyl chloride, polyvinylidene chloride, polystyrene, polyethylene terephthalate, thermoplastic elastomer, polymethyl methacrylate, polysulfone, polyesters, polyolefins, epoxies, phenolics, novolacs, thermosets, thermoplastics, composites, any combination thereof, or any other suitable polymer or flexible material as the present disclosure is not so limited. It should be appreciated that the flexible container may be made of any suitable material that is both compatible with the contents of the fluid (e.g. biocompatible for bioreactor applications) and sufficiently flexible to enable deformation of the container, as the present disclosure is not so limited. The flexible container may also be made of material that may be suitably sterilized (e.g. withstand gamma irradiation, autoclave sterilization, and/or any other appropriate sterilization procedure) for biological or other contamination sensitive applications. The container may also be made of material capable of withstanding temperatures below 0° C., for example −20° C., and/or temperatures above 30° C., for example 37° C. It should also be appreciated that the flexible container may be configured to be a single-use container, though multiuse containers are also contemplated.

It should also be appreciated that the mixing systems described herein may be compatible with flexible containers of any suitable size. For example, the grippers may be configured to receive a flexible container of 1 L. In some embodiments, the grippers may be configured to receive a flexible container of at least 1 mL. 2 mL. 10 mL, 20 mL, 50 mL, 100mL. 200 mL, 500 mL, 1 L, 2 L, 10 L, 50 L, 100 L, 500 L, or any other suitable volume. The grippers may also be configured to receive a flexible container that has a volume that is less than or equal to 1000 L, 500 L, 100 L, 50 L, 10 L, 1 L, and/or any other appropriate volume. Combinations of the foregoing are contemplated including, for example, a gripper that is configured to receive a flexible container with a volume that is between or equal to 1 mL and 1000 L. However, volumes both greater than and less than those noted above are also contemplated as the mixing systems described herein are not limited by the size or scale of the flexible container.

It should be appreciated that the grippers may be made of any material suitable to grip the flexible container. In some embodiments, the material of the grippers may be more rigid than the material of the flexible container. In some embodiments, the grippers may include a multilayer composition. In other embodiments, the grippers may include one or more composite materials to facilitate fabrication and longevity. In other embodiments still, the grippers may include thermoplastics, elastomers, composites, metals, any combination thereof, or any other suitable material, as the present disclosure is not so limited. Accordingly, it should be appreciated that in the grippers may be made from any suitable material, or combination of materials, that exhibit sufficient strength and elasticity to perform the desired functions described herein.

It should be appreciated that the mixing system described herein may be used for any suitable application, including, but not limited to, mixing fluid solutions (including, for example, buffer solutions, cell culture media), homogenizing solutions, such as homogenizing previously frozen samples (which may, for example, include active or pharmaceutic agents), and cell culture applications, such as cell growth or proliferation of suitable cells, including, but not limited to, CHO cells, HEK cells, T cells, stem cells, and/or any other suitable type of cell. In some embodiments, the mixing system may be used to uniformly dethaw a frozen solution. In other embodiments, the mixing system may be used in a bioreactor. In other embodiments still, the mixing system may be used in conjunction with cell culture platforms. In other embodiments still, the mixing system may be used to homogenize or otherwise mix buffers and ingredients contained within the flexible container. It should be appreciated that the mixing system may be used for any suitable application, as the present disclosure is not so limited.

In the various embodiments described herein, a bioreactor may include a compartment configured to contain live organisms or cells that produce biological compounds. These cells or organisms may either be suspended in liquid disposed inside the reactor and/or may be attached to solid particles and/or surfaces disposed inside of the reactor. The environment within the bioreactor may be monitored and maintained for healthy growth of cells. Temperature, pH, dissolved oxygen, and gas flow rates are examples of potential process parameters that may be controlled to permit the cell or organism growth to be healthy, repeatable and reliable.

In some embodiments, the cells, organisms, and/or the particles cells are attached to may be suspended in a liquid contained within a bioreactor to permit the whole, or other desired portion, of the volume in the bioreactor to be used and to enable the production of a high cell density culture. To keep the cells, organisms, and/or microparticles in suspension, the bioreactor media may be stirred, shaken, and/or mixed using the systems and methods as described herein. The mixing rate may affect the mixing ratio, dissolution of oxygen in the media, and the flow profile leading to shear stress to the biological organisms. Hence, the mixing rate may be optimized and controlled for a given mixture. Some cells such as stem cells or T cells are very sensitive to shear stress, and the mixing rate may need to be appropriately controlled to not damage the cells. As noted previously, the described systems and methods may advantageously provide low shear rate mixing which may help enhance the viability of cell cultures.

It should be appreciated that while mechanical actuators are primarily described for actuation of the grippers described herein, any suitable mechanisms capable of applying a deformation to the grippers to induce movement between the retracted and closed configurations may be used as the disclosure is not so limited. For example, electromagnetic actuation, pneumatic actuation, light-responsive actuation, and/or any other appropriate type of actuation method may be used as the present disclosure is not so limited. Accordingly, the grippers may be made of magnetic materials (e.g. polymers with embedded magnetic particles), light-responsive materials, gas-filled channels (for pneumatic actuation), dielectric elastomers, electroactive responsive materials, and/or any other appropriate material depending on the type of actuation applied to the grippers.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

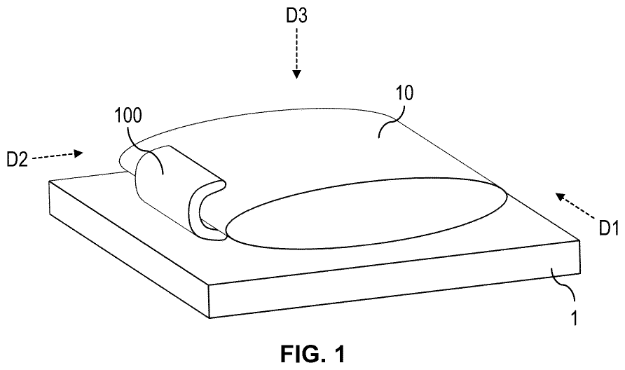

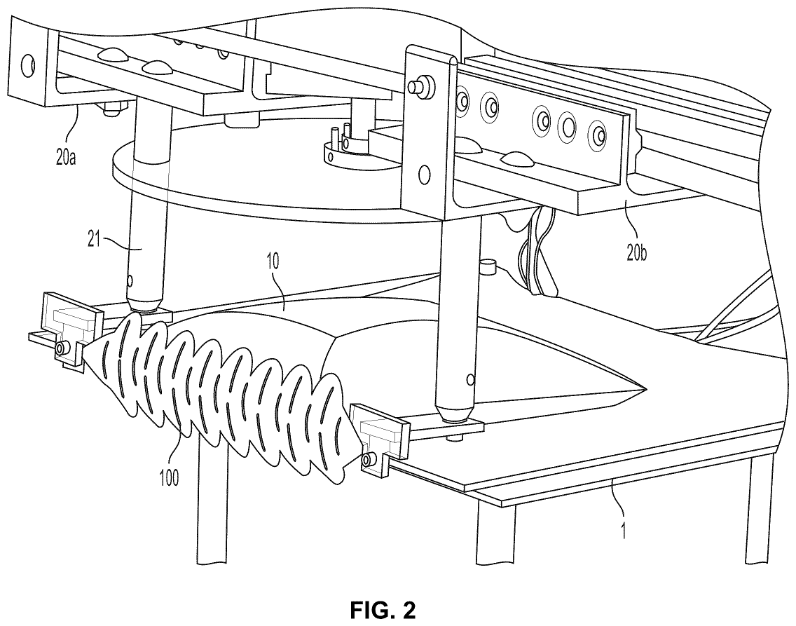

As shown in FIGS. 1 and 2, in some embodiments a mixing system may include a gripper 100 that may be configured to receive a container 10 which may be disposed on a support 1. In FIG. 1, the support is an underlying surface on which the container is fully disposed. However, embodiments in which the flexible container is only partially supported on the support, and a portion of the container overhangs from an edge of the support and is positioned within one or more grippers, see FIG. 2, are also contemplated. In either case, the gripper 100 may be connected to one or more actuators 20a and 20b. Depending on the particular construction, the actuators may be attached to the gripper via corresponding linkages 21, a direct connection between the gripper and actuator(s), and/or any other appropriate arrangement. The one or more actuators may move the associated portions of the gripper apart from one another. This may include moving the portions of the gripper in opposite directions or moving one of the portions of the gripper away from the other while the other portion is held stationary, to axially deform the gripper. While the embodiment shown in FIG. 2 illustrates the actuators 20a. 20b move in opposing directions along the same axis, it should be appreciated that in alternative embodiments, the actuators 20a, 20b may move in a non-linear direction to axially deform the gripper 100.

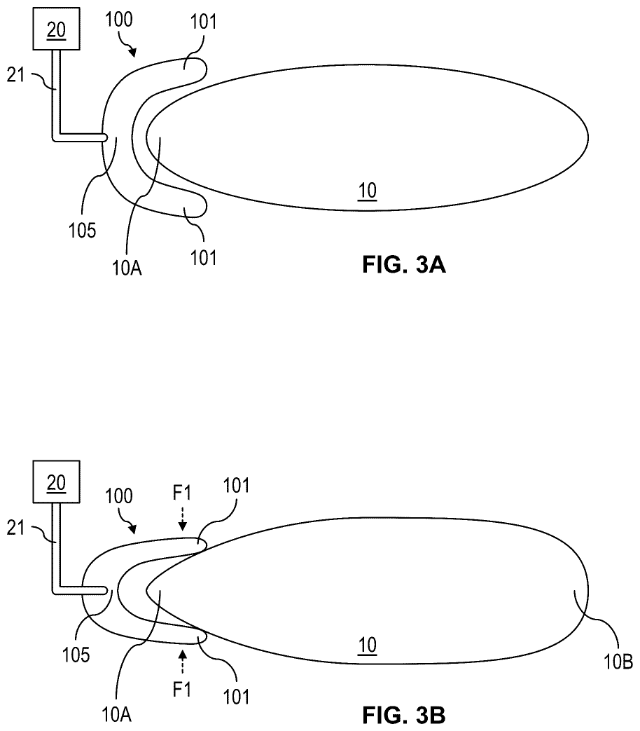

A typical gripper actuation cycle is shown in FIGS. 3A and 3B, viewed along direction D1 shown in FIG. 1. In some embodiments, as shown in FIG. 3A, jaws 101 of the gripper 100 may not be in contact with the container 10 in the fully retracted configuration of the gripper 100, though instances in which the gripper jaws are in contact with the container in the fully retracted configuration are also contemplated. The substrate 105, which may correspond to an elongated elastic sheet, may include the portion of the grippers 100 that includes the slots, hinges, and spines as described previously. The substrate 105 of the gripper 100 may be connected to linkages 21, or other connections, which may permit the opposing portions of the gripper to be connected to one or more actuators 20 (only one shown in FIG. 3A). Upon displacement of the one or more actuators 20, the substrate 105 of the gripper 100 may be axially closed such that the gripper jaws 101 are deformed towards one another with a portion 10A of the container 10 disposed between the jaws, as shown in FIG. 3B. The grippers subsequently apply a compressive force Fl on the portion 10A of the container 10. In this embodiment, the container 10 may be sufficiently compliant such that compression at the portion 10A of the container 10 may result in an expansion of another portion 10B of the container 10. As the cycle is reversed, the jaws of the grippers may move away from one another back to the retracted configuration permitting the compressed portion of the flexible container to return back to its initial configuration prior to compression. As this compressive process is cyclically applied the fluid within the container, and any components suspended in the fluid, may undergo flow, thus, mixing the contents in the container.

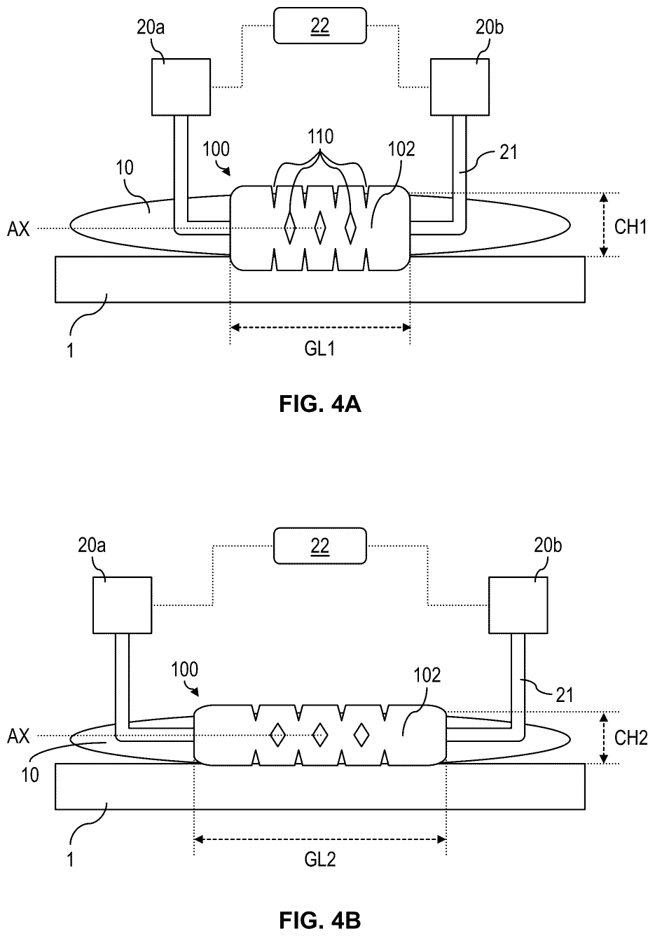

FIGS. 4A and 4B show another view of a half cycle of the gripper 100 along the direction D2 shown in FIG. 1. In the retracted configuration, the container 10 may have a retracted height CH1 while resting on the support 1. The gripper 100 may include a spine 102 and slots 110, which may be distributed along the gripper 100 in a precise pattern. The gripper 100 may have a retracted length GL1. As described previously, the mixing system may include a processor 22 to control the one or more actuators 20a, 20b to displace the end portions of the gripper 100. Upon axial deformation of the spine 102 along the axial direction AX, the gripper 100 may be stretched to an closed configuration with a length GL2 and may subsequently compress a portion of the container 10, as shown in FIG. 4B as the jaws of the gripper are deformed towards one another. Accordingly, the container 10 may have a compressed height CH2 which may be less than the initial height CH1. It should be appreciated that both CH1 and CH2 may be measured at the portion of the container where the gripper 100 is in contact with the container 10 (e.g., an end portion 10A as shown in FIG. 3B). It should be appreciated that in some embodiments, the gripper 100 may not be in contact with the container 10 in the fully retracted configuration, as the present disclosure is not so limited. In other words, the gripper may release the container 10 during cycling. However, embodiments in which the gripper is in contact with a container throughout a compression cycle are also contemplated.

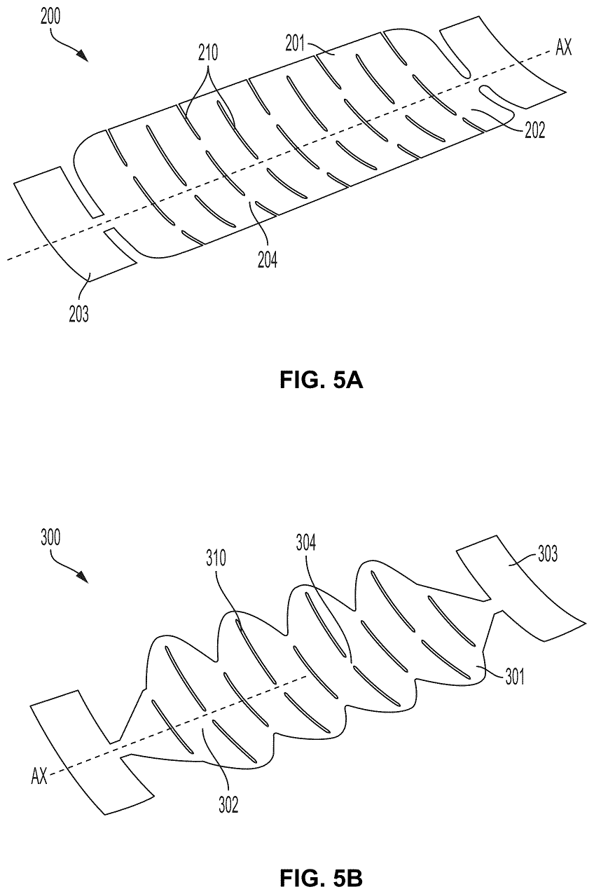

Some exemplary embodiments of grippers that might be used with any of the embodiments disclosed herein are shown in FIGS. 5A-5B. In FIG. 5A, a gripper 200 may have an axial direction AX extending along a longitudinal axis of the gripper along which the gripper 200 may be deformed. The gripper 200 may further include a spine 202 which may extend between two tabs 203 located at opposing end portions of the gripper 200. The tabs 203 may be configured to be connected to one or more actuators via clamps, hooks, or any other appropriate type of connection, see FIGS. 1-4B above, such that the displacement of the one or more actuators may be transferred to the gripper 200 through the tabs 203 to control a deformation applied to the gripper along the depicted axial direction. The gripper 200 may further include slots 210 distributed in a desired pattern along the substrate which in the depicted embodiment is an elastic sheet. The gripper 200 may also include hinges 204 formed by the pattern of slots 210. The hinges may be more compliant than the spine 202 of the gripper due to a reduced cross-sectional area. The gripper 200 may also include jaws 201. which may be configured to compress and release a container 10, as described earlier. The jaws may either be portions of the spine that are deformed and come into contact with a container during use and/or they may be separate structures that extend outwards away from the spine that is to be deformed as the disclosure is not limited to any specific construction. It should be appreciated that while the jaws 201 have edges that run parallel to the axis AX of the gripper 200, in other embodiments, such as in gripper 300 in FIG. 5B, the jaws 301 may have a different geometry. For example, the jaws 301 have a scalloped geometry. Accordingly, it should be appreciated that any suitable shape of the jaws may be used, as the present disclosure is not so limited. Similar to the above embodiment, the gripper 300 may have tabs 303, a spine 302, slots 310, and hinges 304 that are configured to provide the desired functionality of the gripper transitioning between a retracted and closed configuration when a deformation is applied to the gripper. It should also be appreciated that while both embodiments of the gripper 200, 300 shown in FIGS. 5A-5B are substantially planar in the retracted configuration, other embodiments of the gripper may not be substantially planar in the retracted configuration.

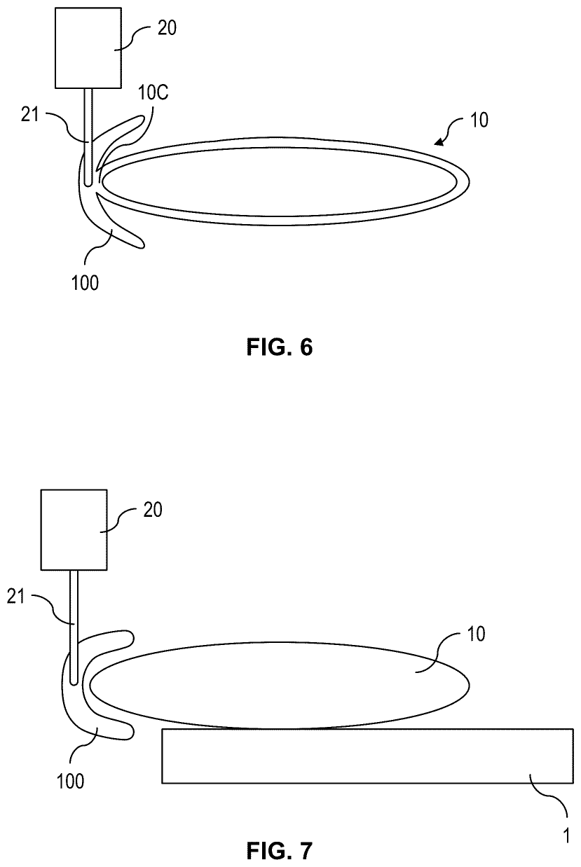

As described previously, in some embodiments, the gripper 100 may be connected to and/or integrally formed with a portion of the container 10. For example, the gripper 100 may be connected at the side 10C of a container 10, as shown in the front view schematic of FIG. 6, taken along the direction D2 shown in FIG. 1. In this embodiment, the gripper 100 may be formed with the container 10 such that there may be a substantial connection between the container 10 and the gripper 100. In other embodiments, not shown, one or more portions of the gripper 100 may be adhered to, attached, or otherwise affixed to the container 10, as the present disclosure is not so limited. Additionally, embodiments in which a gripper is disposed between two layers of film material forming the container or are otherwise integrated with the container are also contemplated.

As described previously and as shown in FIG. 7, the support 1 may only partially support the container 10. This may help to prevent interference of the support 1 with the gripper 100 contacting the container. For example, a portion of the container may extend past an edge of the underlying support where this portion of the container is disposed at least partially within the associated one or more grippers. Container 10 may still be suitably supported, such that even when the gripper 100 is at the retracted configuration, as shown in the front view schematic of FIG. 7, taken along the direction D2 shown in FIG. 1, the container 10 is sufficiently supported.

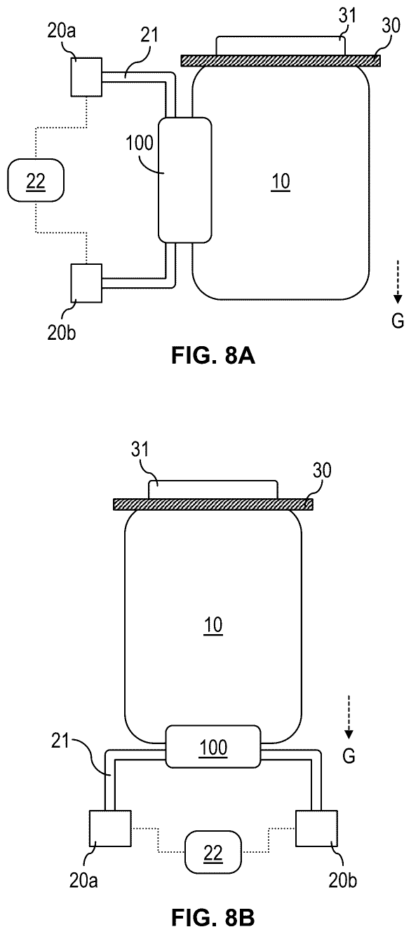

In other embodiments, the container 10 may be supported by hanging the container either in a vertical, horizontal, or other appropriate arrangement relative to a local direction of gravity. A vertical hanging orientation of a container is shown in FIGS. 8A and 8B. In these embodiments, the container 10 may be connected to a clamp 30 and hanging support 31 at a portion of the container 10 removed from an underlying supporting surface (e.g. the ground) (the direction of gravity G is shown for reference). Alternative hanging embodiments are described previously. In embodiments where the container 10 is hanging, the gripper 100 may be positioned at any portion of the container 10, for example at a side portion, as shown in FIG. 8A or opposite the clamp 30, as shown in FIG. 8B. In the embodiment shown in FIG. 8B, the fluid flow within the container 10 may be aided by the force of gravity on the fluid content. It should be appreciated that the gripper 100 may be positioned at any location of the container 10 as the present disclosure is not so limited.

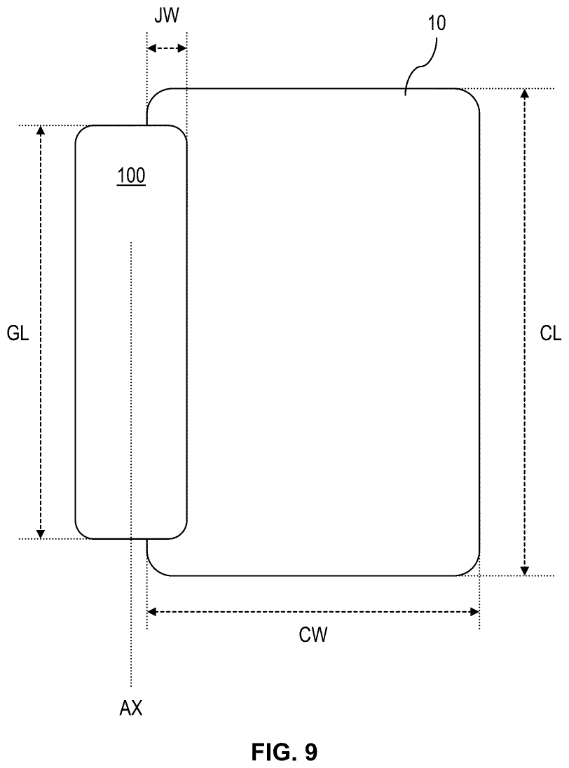

FIG. 9 shows a schematic top view, taken along the direction D3 shown in FIG. 1, of an embodiment of the container 10 with one gripper 100. The gripper 100 may have a gripper length GL measured along the axial direction AX of the gripper and the container 10 may have a container length CL measured along the axial direction AX of the gripper. As described previously, the gripper length GL may be any percentage of the container length CL. For example, the gripper length GL may be 80% of the container length CL as shown in FIG. 9. Additionally, while the gripper 100 is shown to be centrally located along the container length CL, the gripper 100 may be positioned at any suitable location along the depicted side of the container, as the present disclosure is not so limited.

The gripper 100 may also have a jaw width JW measured normal to the axial direction AX. The jaw width JW may be a measurement of how far the gripper 100 spans across the container 10 in the closed configuration. In some embodiments, the gripper 100 may include a substrate 105 (see FIG. 3A) which may not extend across the entire width of the container 10, as described previously. In the embodiment shown in FIG. 9, the jaw width JW is approximately one tenth of the container width CW, measured normal to the axial direction AX. However, it should be appreciated that the jaw width JW may be any suitable proportion of the container width CW, as the present disclosure is not so limited.

It should be appreciated that the dimensions container width and length may be interchangeable, as the grippers may be arranged at any orientation on the container. For example, the grippers may span across at least a portion of the larger dimension of a container. In another example, the grippers may span across at least a portion of the smaller dimension of a container. It should also be appreciated that while rectangular containers have been depicted in the figures, alternative container shapes, including, but not limited to, circular, triangular, or any other suitable shape may be used, as the present disclosure is not so limited.

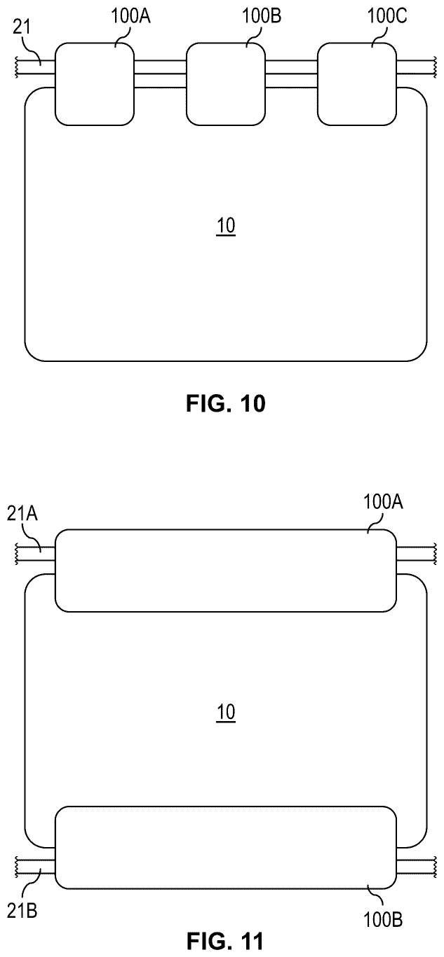

FIG. 10 shows a schematic top view, taken along the direction D3 shown in FIG. 1, of one embodiment of a mixing system with three grippers 100A-100C located on the same side of a container 10. In this embodiment, each gripper 100A-100C has a gripper length GL shorter than the container length CL, as described in FIG. 9. While all three grippers are shown to be connected to the same linkage 21, it should be appreciated that in some embodiments, each gripper 100A-100C may be connected to a separate set of actuators and linkages 21.

Another embodiment of a mixing system with multiple grippers 100A, 100B located at different end portions of the container 10 is shown in FIG. 11. In this embodiment, the grippers 100A, 100B are each connected to an independent linkage 21A, 21B. In other embodiments, the grippers 100A, 100B may be connected to the same linkages 21. It should be appreciated that any suitable configuration of grippers 100A, 100B, and linkages 21A, 21B may be used as the present disclosure is not so limited.

In the above embodiments, linkages for connecting the grippers to one or more actuators are described. However, direct connections and/or different types of connections between the actuators and the grippers may also be used as the disclosure is not so limited.

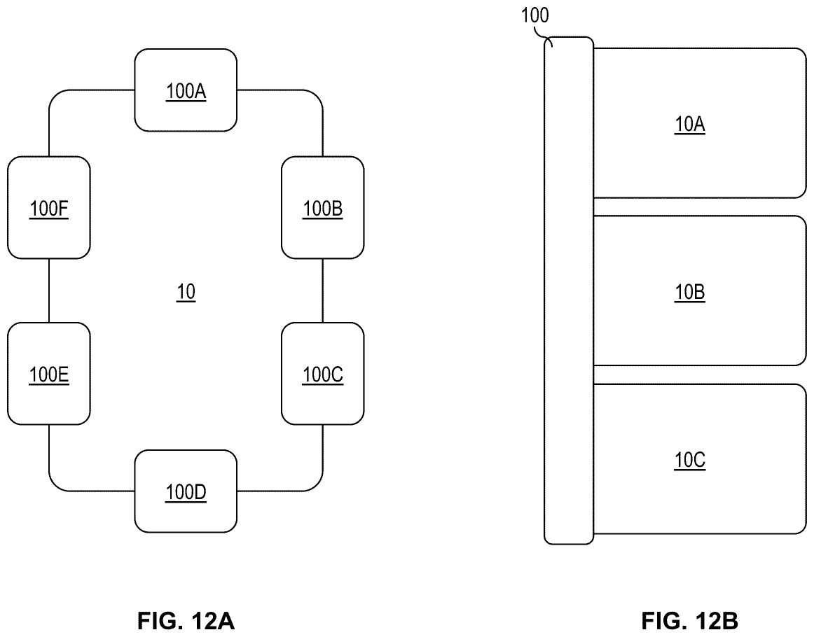

In other embodiments, there may be a series of grippers 100A-F positioned around a perimeter of a container 10, as shown in FIG. 12A. The grippers 100A-100F may be operated by an associated processor as previously described such that the grippers may be operated in a desired sequence. For example, each gripper may be operated with a different phase delay such the actuation of each gripper begins after the actuation of a preceding gripper begins. In this way, the grippers 100A-100F may help to induce a circular flow pattern in the container 10 which may improve the mixing within the container when compared to a mixing system with only one gripper.

In some embodiments, the gripper 100 may be suitably large to accommodate multiple containers 10A-10C in parallel, as shown in FIG. 12B. In this embodiment, the gripper 100 may deform all three containers 10A-10C with similar operation, which may expedite processing time and reduce the overall footprint of the mixing system for multiple containers.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter.

1. A fluid mixing system comprising:
one or more supports configured to support a flexible container containing a fluid; and
one or more grippers configured to receive at least a portion of the flexible container within the one or more grippers when the container is supported by the one or more supports,
wherein the one or more grippers are configured to deform the flexible container to induce flow of the fluid within the flexible container.

2. The fluid mixing system of claim 1, wherein the one or more grippers comprise a plurality of slots arranged in a pattern on a substrate of the grippers, wherein the plurality of slots define one or more hinges and one or more spines extending at least partially along an axial direction of the substrate.

3. The fluid mixing system of claim 2, wherein the one or more grippers are configured to move between a closed configuration and a retracted configuration when the one or more spines are deformed in the axial direction.

4. The fluid mixing system of claim 2, wherein the one or more grippers comprise a plurality of jaws formed in the substrate.

5. The fluid mixing system of claim 1, wherein the fluid is a liquid solution.

6. The fluid mixing system of claim 1, further comprising one or more actuators configured to deform the one or more grippers in an axial direction.

7. The fluid mixing system of claim 1, wherein the one or more grippers are each configured to extend between 25% and 75% of a length of the flexible container.

8. The fluid mixing system of claim 1, wherein the one or more grippers are attached to at least a portion of the flexible container.

9. A flexible container comprising:
one or more flexible films defining a fluid volume; and
one or more grippers connected to the one or more flexible films and configured to deform the one or more flexible films, wherein each gripper of the one or more grippers includes:
a substrate with a plurality of jaws formed in the substrate, and
wherein the one or more grippers are attached to at least a portion of the one or more flexible films such that when the one or more grippers are deformed in an axial direction, the one or more grippers deform the fluid volume.

10. The flexible container of claim 9, wherein the one or more grippers further comprise a plurality of slots arranged in a pattern on the substrate, wherein the plurality of slots define one or more hinges and one or more spines extending at least partially along an axial direction of the substrate.

11. The flexible container of claim 10, wherein the one or more grippers are configured to move between a closed configuration and a retracted configuration when the one or more spines are deformed in the axial direction.

12. The flexible container of claim 9, wherein a portion of the one or more grippers are connected to a portion of the one or more flexible films to connect the one or more grippers.

13. The flexible container of claim 9, wherein the one or more flexible films includes two or more flexible films, and wherein the one or more grippers are disposed between the two or more flexible films.

14. The flexible container of claim 9, wherein the one or more grippers are each configured to extend between 25% and 75% of a length of the flexible container.

15. A method of mixing a fluid disposed inside of a flexible container, the method comprising:
displacing opposing end portions of one or more grippers in opposing directions; and
closing a plurality of jaws of the one or more grippers in response to the applied displacement to compress at least a portion of the flexible container between the plurality of jaws, wherein the fluid disposed inside of the flexible container undergoes mixing upon compression of the container.

16. The method of claim 15, wherein the one or more grippers comprise a plurality of slots arranged in a pattern on a substrate, wherein the plurality of slots define one or more hinges and one or more spines extending at least partially along an axial direction of the substrate.

17. The method of claim 16, further comprising axially deforming the one or more spines in response to the applied displacement.

18. (canceled)

19. The method of claim 15, wherein the one or more grippers are attached to at least a portion of the flexible container.

20. The method of claim 15, further comprising actuating one or more actuators operatively coupled to the opposing end portions of the one or more grippers to displace the opposing end portions.

21. The method of claim 15, further comprising positioning at least a portion of the flexible container in the one or more grippers.
